(19) United States
(12) Patent Application Publication
(10) Pub. No.: US 2013/0029085 A1
(43) Pub. Date: Jan. 31, 2013

(54) Conforming Plate

(71) Applicant: Eric Liao, Taichung City (TW)

(72) Inventor: Eric Liao, Taichung City (TW)

(21) Appl. No.: 13/193,414

(22) Filed: Jul. 28, 2011

(51) Int. Cl. B32B 3/02

(52) U.S. Cl. 428/81; 428/157

(57) ABSTRACT

A conforming plate includes an upper face extending parallel to a lower face and facets each extending between the upper and lower faces. The upper face is smaller than the lower face, thus forming an edge between the lower face and each of the facets. The conforming plate further includes a concave facet extending on the lower face beneath one of the edge, thus providing the conforming plate with a thin portion to be pinched by a user's fingers.

### BACKGROUND OF INVENTION

1. Field of Invention

The present invention relates to a conforming plate and, more particularly, to a conforming plate including a polygonal profile consisting of various edges for flattening, chamfering, rounding, and making a rib and a groove.

2. Related Prior Art

Filler is often filled in a corner at the intersection of two faces that extend perpendicular to each other or a gap between two faces that extend parallel to each other. The filler includes but not limited to mastic, adhesive, sealant and putty. Filler that is filled in a gap between two faces that extend parallel to each other is often processed with a scraper so that the filler is flush with the faces that extend parallel to each other. It is however difficult to process filler that is filled in a corner at the intersection of two faces that extend perpendicular to each other with a scraper to make the filler flush with the faces that extend parallel to each other.

Furthermore, it is sometimes desirable to make a decoration such as a rib or groove on a wall. It is however difficult to make a rib or groove on a wall.

The present invention is therefore intended to obviate or at least alleviate the problems encountered in prior art.

### SUMMARY OF INVENTION

It is an objective of the present invention to provide a conforming plate for processing filler.

To achieve the foregoing objectives, the conforming plate includes an upper face, a lower face, facets, edges and a concave facet. The upper face extends parallel to the lower face. Each of the facets extends between the upper and lower faces. The upper face is smaller than the lower face, thus forming each of the edges between the lower face and a related one of the facets. The concave facet extends on the lower face beneath one of the edge, thus providing the conforming plate with a thin portion to be pinched by a user's fingers.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a conforming plate according to the preferred embodiment of the present invention;

FIG. 2 is another perspective view of the top of the conforming plate shown in FIG. 1;

FIG. 3 is a perspective view of the bottom of the conforming plate shown in FIG. 1;

FIG. 4 is a cross-sectional view of filler filled in a corner processed with an edge of the conforming plate shown in FIG. 1;

FIG. 5 is a cross-sectional view of filler filled in a corner processed with another edge of the conforming plate shown in FIG. 1;

FIG. 6 is a cross-sectional view of filler filled in a gap processed with another edge of the conforming plate shown in FIG. 1;

FIG. 7 is a cross-sectional view of filler filled in a corner processed with a recess of the conforming plate shown in FIG. 1; and

FIG. 8 is a cross-sectional view of filler filled in a corner processed with a boss of the conforming plate shown in FIG. 1.

### DETAILED DESCRIPTION OF PREFERRED EMBODIMENT

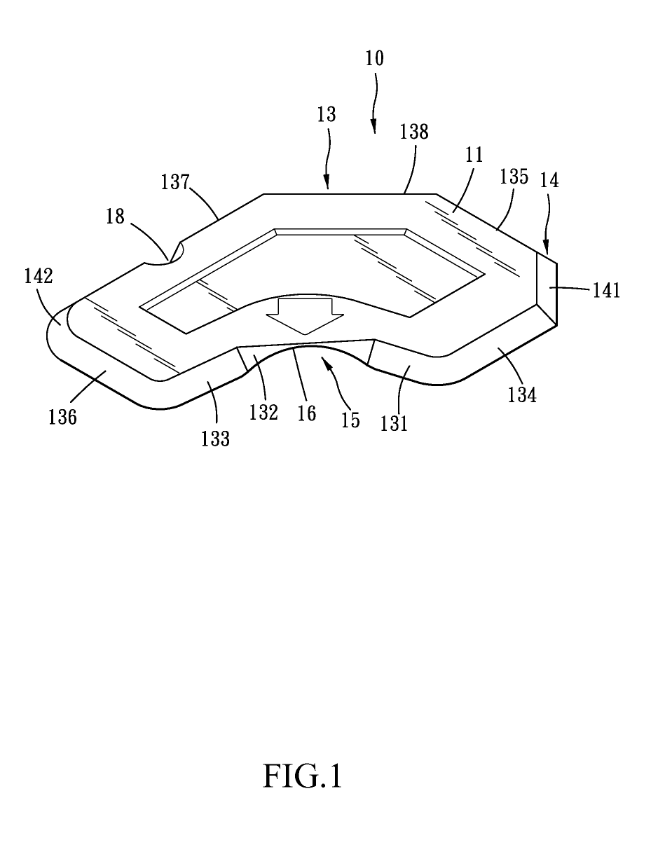

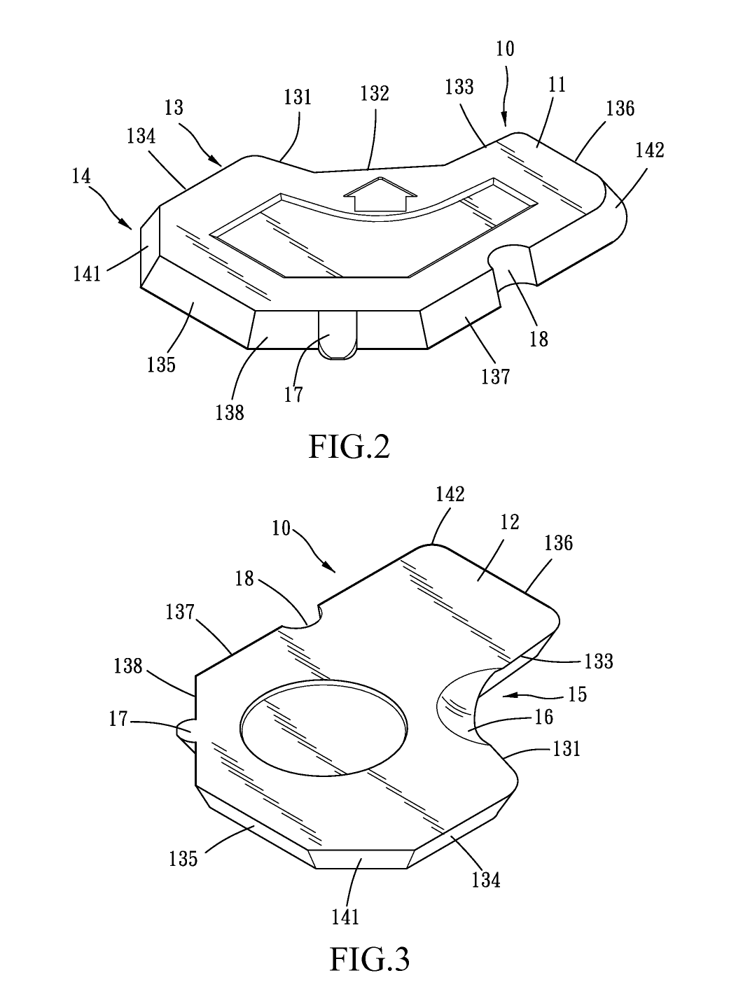

Referring to FIGS. 1 through 3, there is shown a conforming plate 10 in accordance with the preferred embodiment of the present invention. The conforming plate 10 is preferably made of a plastic material. The conforming plate 10 is made with a proper thickness and a polygonal profile so that it includes an upper face 11, a lower face 12 extending parallel to the upper face 11, and facets 13 each extending between the upper face 11 and the lower face 12. The the upper face 11 is similar to but smaller than the lower face 12 so that the facets 13 converge toward the upper face 11. Thus, there are sequentially edges 131, 132, 133, 136, 137, 138, 135 and 134 each formed between the lower face 12 and a related one of the facets 13. The edges 131, 132 and 132 together define a concave portion of the conforming plate 10.

The conforming plate 10 further includes a set 14 of angles. The angles include a chamfer 141 formed between the edges 134 and 135 that extend perpendicular to each other and a round angle 142 formed between the edges 136 and 137 that extend perpendicular to each other. As shown, the chamfer 141 is actually an edge similar to but smaller than any of the edges 131, 132, 133, 136, 137, 138, 135 and 134. The chamber 141 may however be a concave portion.

The conforming plate 10 further includes a concave facet 16 extending on the lower face 12, a boss 17 formed on the edge 138, and a recess 18 defined in the edge 137. The concave facet 16 is located beneath the edge 132, thus forming a thin portion of the conforming plate 10 that can easily be pinched with a user's fingers.

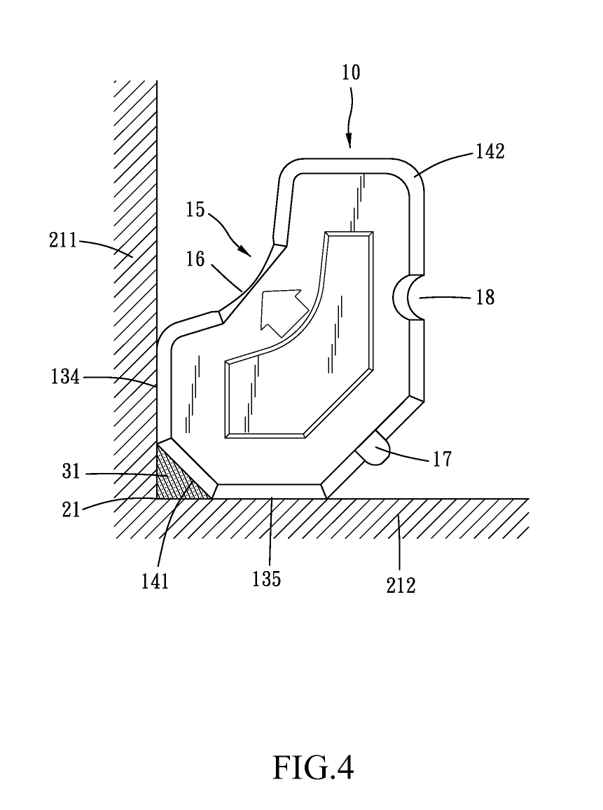

Referring to FIG. 4, there is shown a corner 21 at the intersection of two flat faces 211 and 212 that extend perpendicular to each other. The flat faces 211 and 212 may be two walls or a wall and a floor. Filler 31 is filled in the corner 21 and processed with the conforming plate 10. The edge 134 is in contact with the flat face 211, the edge 135 is in contact with the flat face 212, and the chamfer 141 is in contact with the filler 31. The conforming plate 10 is moved so that the chamfer 141 is moved on the filler 31, thus providing the filler 31 with a flat face.

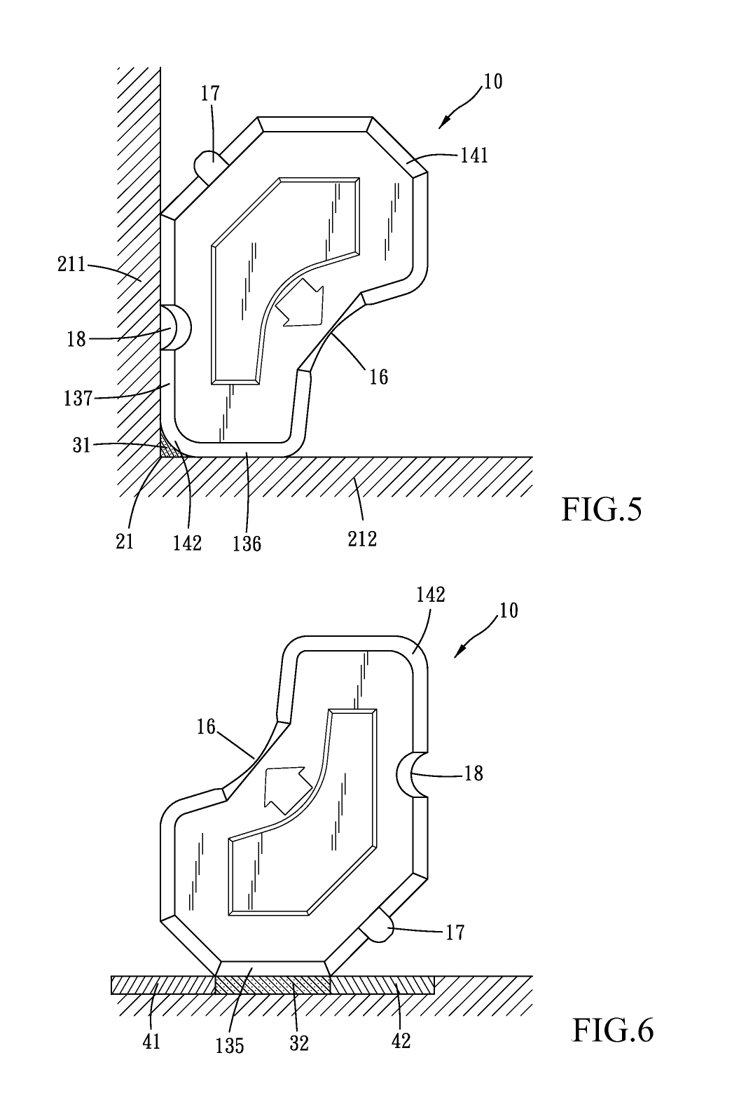

Referring to FIG. 5, the edge 137 is in contact with the flat face 211, the edge 136 is in contact with the flat face 212, and the rounded angle 142 is in contact with the filler 31. The conforming plate 10 is moved so that the rounded angle 142 is moved on the filler 31, thus providing the filler 31 with a concave face.

Referring to FIG. 6, there is shown a gap between two planks 41 and 42 that extend parallel to each other. Filler 32 is filled in the gap and processed with the conforming plate 10. The edge 135 is in contact with at least portions of the planks 41 and 42 and the filler 32. The conforming plate 10 is moved so that the edge 135 is moved on the planks 41 and 42 and the filler 32, thus making the filler 32 flush with the planks 41 and 42.

Referring to FIG. 6, the edge 137 is in contact with at least portions of the planks 41 and 42, and the recess 18 is located on the filler 32. The conforming plate 10 is moved, thus making a rib on the filler 32 because of the recess 18.

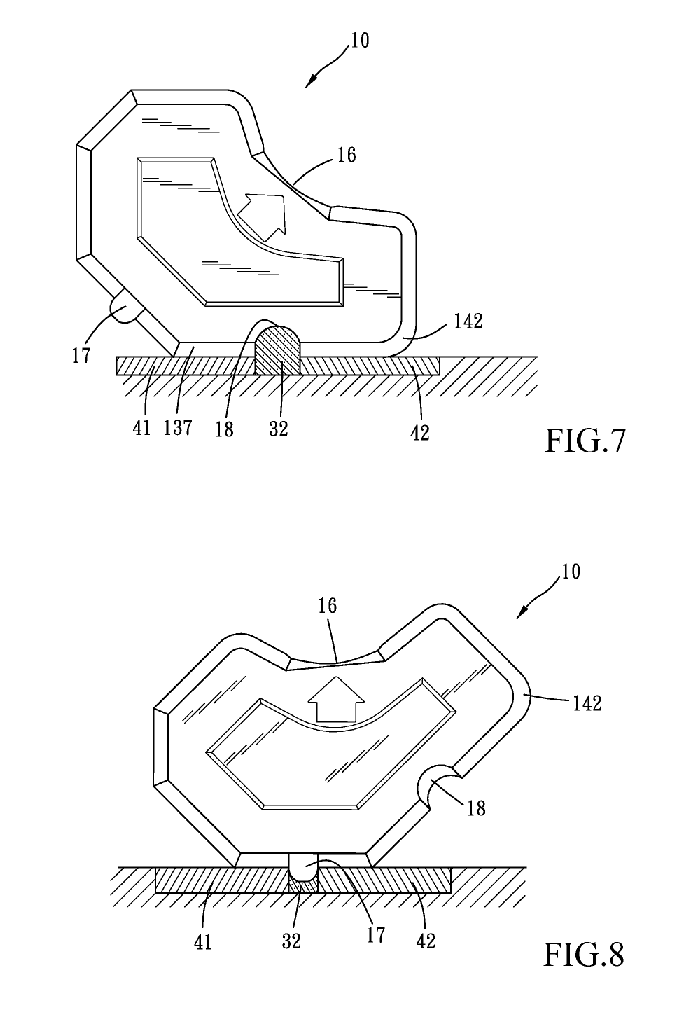

Referring to FIG. 7, the edge 138 is in contact with at least portions of the planks 41 and 42, and the boss 17 is inserted in the filler 32. The conforming plate 10 is moved, thus making a groove in the filler 32 because of the boss 17.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A conforming plate including
an upper face;
a lower face extending parallel to the upper face;
edges extending around the lower face; and
a concave facet extending on the lower face beneath one of the edges , thus providing a thin portion to be pinched.

2. The conforming plate according to claim 1, wherein three of the edges, together define a concave portion of the conforming plate, wherein the concave facet extends beneath the middle one of the edges that define the concave portion of the conforming plate.

3. The conforming plate according to claim 1, further including a chamfer formed between two of the edges.

4. The conforming plate according to claim 1, further including a round angle formed between two of the edges.

5. The conforming plate according to claim 1, further including a boss formed on one of the edges.

6. The conforming plate according to claim 1, further including a recess in one of the edges.

7. The conforming plate according to claim 1, further including facets each extending between the upper and lower faces, wherein the upper face is smaller than the lower face, thus providing each of the edges between the lower face and a related one of the facets.

8. The conforming plate according to claim 1, wherein the conforming plate is made of a plastic material.
